(19) United States
(12) Patent Application Publication
(10) Pub. No.: US 2019/0035098 A1
(43) Pub. Date: Jan. 31, 2019

(54) Electronic device and method for generating, from at least one pair of successive images of a scene, a depth map of the scene, associated drone and computer program

(71) Applicant: PARROT DRONES, Paris (FR)

(72) Inventor: Clément Pinard, Paris (FR)

(21) Appl. No.: 16/043,790

(22) Filed: Jul. 24, 2018

(30) Foreign Application Priority Data
Jul. 25, 2017 (FR) 17 57049

(51) Int. Cl. G06T 7/593; B64C 39/02; B64D 47/08; G06N 3/08

(52) U.S. Cl. CPC G06T 7/593; B64C 39/024; B64C 2201/123; G06N 3/084; B64D 47/08

(57) ABSTRACT

An electronic device for generating, from a pair of successive images of a scene including a set of object(s), a depth map of the scene, comprises: a module for acquiring a pair of images of the scene, taken by a sensor, a module for computing, via a neural network, an intermediate depth map, each intermediate map being computed for a respective acquired pair of images and having a value indicative of a depth for each object of the scene, an input variable of the neural network being the acquired pair of images, an output variable of the neural network being the intermediate map, and a module for generating the depth map of the scene from at least one computed intermediate map.

### CROSS-RELATED APPLICATIONS

This patent application claims the benefit of document FR 17 57049 filed on Jul. 25, 2017 which is hereby incorporated by reference.

### FIELD

The present invention relates to an electronic device for generating, from at least one pair of successive images of a scene including a set of object(s), a depth map of the scene.

The invention also relates to a drone comprising an image sensor configured to take at least one pair of successive images of the scene and such an electronic device for generating the depth map of the scene.

The invention also relates to a method for generating, from at least one pair of successive images of a scene including a set of object(s), a depth map of the scene, the method being carried out by such an electronic generating device.

The invention also relates to a non-transitory computer-readable medium including a computer program including software instructions which, when executed by a computer, implement such a generating method.

The invention relates to the field of drones, i.e., remotely-piloted flying motorized apparatuses. The invention in particular applies to rotary-wing drones, such as quadcopters, while also being applicable to other types of drones, for example fixed-wing drones.

The invention is particularly useful when the drone is in a tracking mode in order to track a given target, such as the pilot of the drone engaging in an athletic activity and must then be capable of detecting obstacles that may be located on its trajectory or nearby.

The invention offers many applications, in particular for improved obstacle detection.

### BACKGROUND

For obstacle detection by a drone, a drone is known equipped with a remote laser detection device or LIDAR (Light Detection and Ranging) device or LADAR (LAser Detection and Ranging) device. Also known is a drone equipped with a camera working on the time of flight (TOF) principle. To that end, the TOF camera illuminates the objects of the scene with a flash of light and calculates the time that this flash takes to make the journey between the object and the camera. Also known is a drone equipped with a stereoscopic camera, such as a SLAM (Simultaneous Localization And Mapping) camera.

When the drone is equipped with a monocular camera, the detection is more delicate, and it is then generally known to use the movement of the camera, and in particular the structure of the movement. Other techniques, for example SLAM, are used with non-structured movements, producing very approximate three-dimensional maps and requiring significant calculations to keep an outline of the structure of the scene and to align newly detected points on existing points.

However, such an obstacle detection with a monocular camera is not very effective.

### SUMMARY

The aim of the invention is then to propose an electronic device and an associated method that allow a more effective generation of a depth map of the scene, from at least one pair of successive images of a scene.

To that end, the invention relates to an electronic device for generating, from at least one pair of successive images of a scene including a set of object(s), a depth map of the scene, the device comprising:
an acquisition module configured to acquire at least one pair of successive images, taken by an image sensor, of the scene including the set of object(s),
a computation module configured to compute, via a neural network, at least one intermediate depth map, each intermediate map being computed for a respective acquired pair of images and having a value indicative of a depth for each object of the scene, the depth being the distance between the sensor and a plane passing through the respective object, parallel to a reference plane of the sensor, an input variable of the neural network being the acquired pair of images, an output variable of the neural network being the intermediate map,
a generating module configured to generate the depth map of the scene from at least one computed intermediate map, the depth map including a set of element(s), each element being associated with an object and having a value dependent on the depth between the sensor and said object.

According to other advantageous aspects of the invention, the electronic generating device comprises one or more of the following features, considered alone or according to all technically possible combinations:
the computing module is configured to compute at least two intermediate maps for the same scene;
the computing module is further configured to modify an average of the indicative depth values between first and second intermediate maps, respectively computed for first and second pairs of acquired images, by selecting the second pair with a temporal deviation between the images that is modified relative to that of the first pair;
the computing module is configured to compute at least two intermediate maps for the same scene, the computed intermediate maps having respective averages with indicative depth values that are different from one intermediate map to the other, and further for computing a merged intermediate map by obtaining a weighted sum of the computed intermediate maps, and the generating module is configured to generate the depth map from the merged intermediate map;
the computing module is configured to perform partitioning in k-averages on a computed intermediate map, in order to determine n desired different respective averages for a later computation of n intermediate maps, n being an integer greater than or equal to 2;
the generating module is configured to generate the depth map by applying a corrective scale factor to the or each computed intermediate map, the corrective scale factor depending on a ratio between the temporal deviation between the images of the acquired pair for which the intermediate map has been computed and a predefined temporal deviation, used for prior learning of the neural network;
each element of the depth map is a pixel, and each object is the entity of the scene corresponding to the pixel of the taken image; and
the image sensor extends along an extension plane, and the reference plane is a plane parallel to the extension plane, such as a plane combined with the extension plane.

The invention also relates to a drone comprising an image sensor configured to take at least one pair of successive images of the scene including a set of object(s), and an electronic generating device configured to generate a depth map of the scene, from the at least one pair of successive images of the scene taken by the sensor, in which the electronic generating device is as defined above.

The invention also relates to a method for generating, from at least one pair of successive images of a scene including a set of object(s), a depth map of the scene, the method being carried out by such an electronic generating device, and comprising:
acquiring at least one pair of successive images, taken by an image sensor, of the scene including the set of object(s),
computing, via a neural network, at least one intermediate depth map, each intermediate map being computed for a respective acquired pair of images and having a value indicative of a depth for each object of the scene, the depth being the distance between the sensor and a plane passing through the respective object, parallel to a reference plane of the sensor, an input variable of the neural network being the acquired pair of images, an output variable of the neural network being the intermediate map, and
generating the depth map of the scene from at least one computed intermediate map, the depth map including a set of element(s), each element being associated with an object and having a value dependent on the depth between the sensor and said object.

The invention also relates to a non-transitory computer-readable medium including a computer program including software instructions which, when executed by a computer, implement a generating method as defined above.

### BRIEF DESCRIPTION OF THE DRAWINGS

These features and advantages of the invention will appear more clearly upon reading the following description, provided solely as a non-limiting example, and done in reference to the appended drawings, in which:

FIG. 1 is a schematic illustration of a drone comprising at least an image sensor and an electronic device for generating, from at least one pair of successive images of a scene including a set of object(s), a depth map of the scene;

FIG. 2 is an illustration of an artificial neural network implemented by a computing module included in the generating device of FIG. 1;

FIG. 3 is a block diagram of the generating device of FIG. 1, according to an optional addition of the invention with the computation of a merged intermediate map;

FIG. 4 is a flowchart of a method for generating, from at least one pair of successive images of a scene including a set of object(s), a depth map of the scene, according to the invention;

FIG. 5 is a curve showing an average depth error as a function of a distance in pixels in the depth map from an expansion focal point;

FIGS. 6 to 9 are images illustrating the results obtained by the electronic generating device according to the invention compared with a reference computation of the depth map of the scene, FIG. 6 showing an image of the scene, FIG. 7 showing the depth map of the scene obtained with the reference computation, FIG. 8 showing the depth map of the scene obtained with the generating device according to the invention, and FIG. 9 showing the depth errors between the depth map obtained with the generating device according to the invention and that obtained with the reference computation; and

FIGS. 10 to 13 are images illustrating the computation of a merged intermediate map, FIG. 10 showing an image of the scene, FIG. 11 showing a first intermediate depth map, FIG. 12 showing a second intermediate depth map and FIG. 13 showing the merged intermediate map resulting from the merging of the first and second intermediate depth maps.

### DETAILED DESCRIPTION

In the following description, the expression “substantially equal to” defines a relationship of equality to within plus or minus 10%.

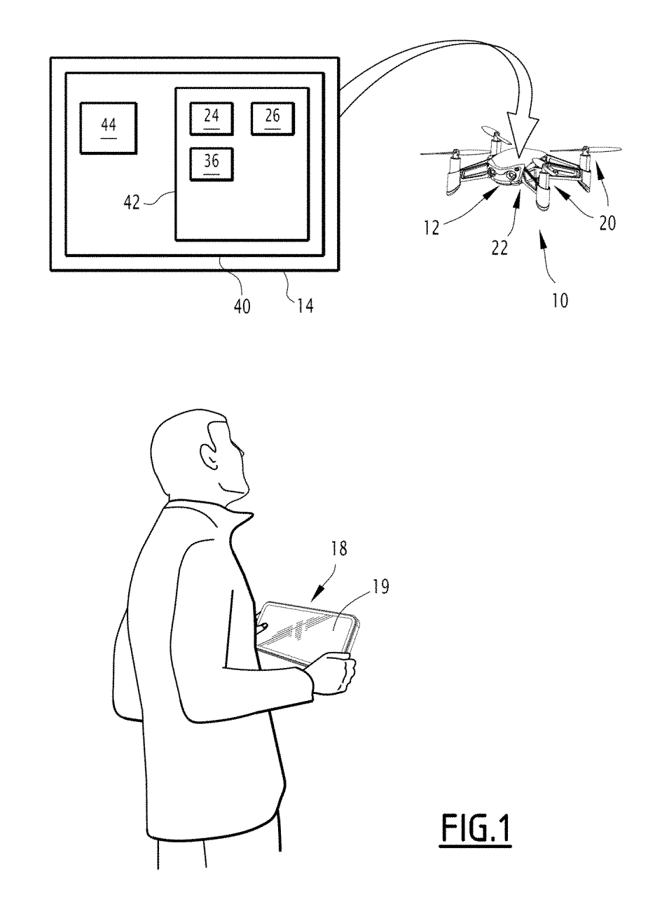

In FIG. 1, a drone 10, i.e., an aircraft with no pilot on board, comprises an image sensor 12 configured to take at least one pair of successive images of a scene S including a set of object(s), and an electronic generating device 14 configured to generate a depth map 16 of the scene S, from the at least one pair of successive images I_{t-Δt}, Iₜ of the scene taken by the sensor 12.

The drone 10 is a motorized flying vehicle able to be piloted remotely, in particular via a joystick 18 equipped with a display screen 19.

The drone 10 is for example a rotary-wing drone, including at least one rotor 20. In FIG. 1, the drone includes a plurality of rotors 20, and is then called multi-rotor drone. The number of rotors 20 is in particular equal to 4 in this example, and the drone 10 is then a quadrotor drone. In an alternative that is not shown, the drone 10 is a fixed-wing drone.

The drone 10 includes a transmission module 22 configured to exchange data, preferably by radio waves, with one or several pieces of electronic equipment, in particular with the lever 18, or even with other electronic elements to transmit the image(s) acquired by the image sensor 12.

The image sensor 12 is for example a front-viewing camera making it possible to obtain an image of the scene toward which the drone 10 is oriented. Alternatively or additionally, the image sensor 12 is a vertical-viewing camera, not shown, pointing downward and configured to capture successive images of terrain flown over by the drone 10.

The image sensor 12 extends in an extension plane. The image sensor 12 for example comprises a matrix photodetector including a plurality of photosites, each photosite corresponding to a respective pixel of the image taken by the sensor 12. The extension plane then corresponds to the plane of the matrix photodetector.

The electronic generating device 14 is for example on board the drone 10, as shown in FIG. 1.

Alternatively, the electronic generating device 14 is a separate electronic device remote from the drone 10, the electronic generating device 14 then being suitable for communicating with the drone 10, in particular with the image sensor 12, via the transmission module 22 on board the drone 10.

The electronic generating device 14 comprises an acquisition module 24 configured to acquire at least one pair of successive images I_{t-Δt}, Iₜ of the scene S, taken by the image sensor 12. The acquired successive images I_{t-Δt}, Iₜ have been taken at respective moments in time t-Δt and t, t representing the moment in time at which the last acquired image of the pair was taken and Δt representing the time deviation between the respective moments at which the two acquired images of the pair were taken.

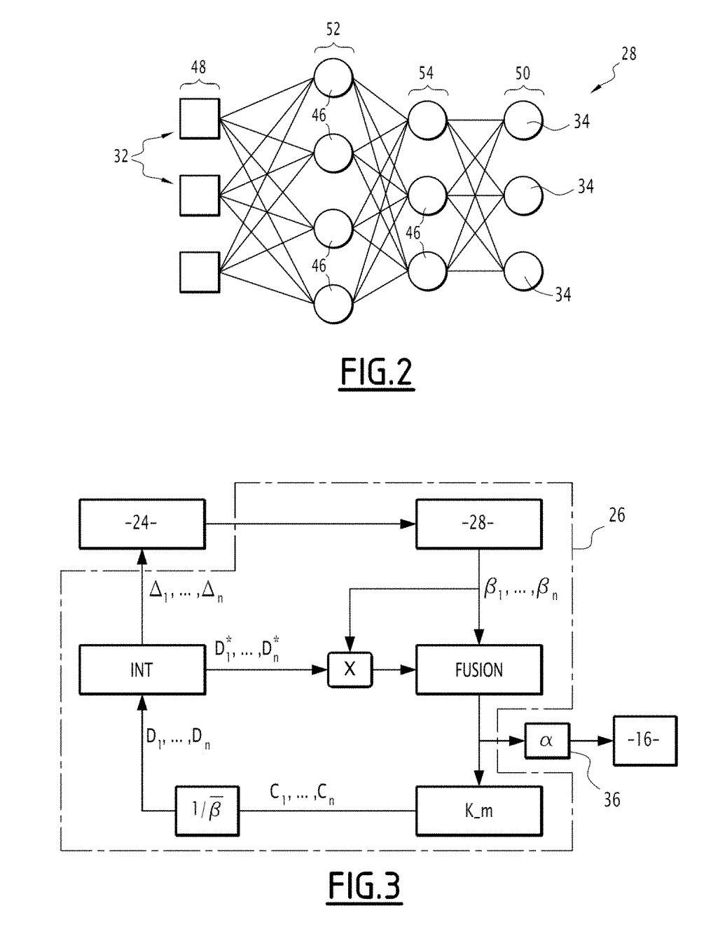

The electronic generating device 14 comprises a computation module 26 configured to compute, via a neural network 28, at least one intermediate depth map 30, each intermediate map 30 being computed for a respective acquired pair of images I_{t-Δt}, Iₜ and having a value indicative of a depth for each object of the scene S. An input variable 32 of the neural network 28 is the acquired pair of images I_{t-Δt}, Iₜ, and an output variable 34 of the neural network 28 is the intermediate map 30, as shown in FIG. 2.

The depth is the distance between the sensor 12 and a plane passing through the respective object, parallel to a reference plane of the sensor 12. The reference plane is a plane parallel to the extension plane of the sensor 12, such as a plane combined with the extension plane of the sensor 12. The depth is then preferably the distance between the plane of the matrix photodetector of the sensor 12 and a plane passing through the respective object, parallel to the reference plane of the sensor 12.

The electronic generating device 14 comprises a generating module 36 configured to generate the depth map 16 of the scene S from at least one computed intermediate map 30.

In the example of FIG. 1, the electronic generating device 14 includes an information processing unit 40, for example made up of a memory 42 and a processor 44, such as a processor of the GPU (Graphics Processing Unit) or VPU (Vision Processing Unit) type associated with the memory 42.

The depth map 16 of the scene S includes a set of element(s), each element being associated with an object and having a value dependent on the depth between the sensor 12 and said object. Each element of the depth map 16 is for example a pixel, and each object is the entity of the scene corresponding to the pixel of the taken image. The value dependent on the depth between the sensor 12 and said object, shown on the depth map 16, as well as each intermediate map 30, is for example a gray level or an RGB value, typically corresponding to a percentage of a maximum depth value, this percentage then providing a correspondence with the value of the depth thus shown.

The lever 18 is known in itself and makes it possible to pilot the drone 10. In the example of FIG. 1, the lever 18 is implemented by a smartphone or electronic tablet, including the display screen 19, preferably touch-sensitive. In an alternative that is not shown, the lever 18 comprises two gripping handles, each being intended to be grasped by a respective hand of the pilot, a plurality of control members, including two joysticks, each being arranged near a respective gripping handle and being intended to be actuated by the pilot, preferably by a respective thumb.

The lever 18 comprises a radio antenna and a radio transceiver, not shown, for exchanging data by radio waves with the drone 10, both uplink and downlink.

In the example of FIG. 1, the acquisition module 24, the computing module 26 and the generating module 36 are each made in the form of software executable by the processor 44. The memory 42 of the information processing unit 40 is then able to store acquisition software configured to acquire at least one pair of successive images I_{t-Δt}, Iₜ of the scene S, taken by the image sensor 12, computing software configured to compute, via the neural network 28, the at least one intermediate depth map 30 and generating software configured to generate the depth map 16 of the scene S from the at least one computed intermediate map 30. The processor 44 of the information processing unit 40 is then able to execute the acquisition software, the computing software and the generating software.

In an alternative that is not shown, the acquisition module 24, the computing module 26 and the generating module 36 are each made in the form of a programmable logic component, such as an FPGA (Field Programmable Gate Array), or in the form of a dedicated integrated circuit, such as an ASIC (Applications Specific Integrated Circuit).

The computing module 26 is configured to compute, via the neural network 28, the at least one intermediate depth map 30.

As an optional addition, the computing module 26 is configured to compute at least two intermediate maps 30 for the same scene S.

Also as an optional addition, the computing module 26 is further configured to modify an average of the indicative depth values between first and second intermediate maps 30, respectively computed for first and second pairs of acquired images, by selecting the second pair, also called following pair, or next pair, with a temporal deviation Δₜ₊₁ between the images that is modified relative to that Δₜ of the first pair, also called previous pair.

According to this optional addition, the computing module 26 is for example configured to compute an optimal movement Dₒₚₜᵢₘₐₗ(t+1) for the next pair of acquired images from an average depth target value) β̅. This optimal movement Dₒₚₜᵢₘₐₗ(t+1) is also called desired movement, or target movement.

The optimal movement Dₒₚₜᵢₘₐₗ(t+1) is for example computed using the following equations:

$${D}_{optimal} ( t + 1 ) = \frac{E ( Ϛ ( t ) )}{α \cdot \overline{β}} \qquad ( 1 )$$

where E( [symbol] (t)) is the average of the values of the first intermediate map 30, i.e., the previous intermediate map from which the target movement, then the temporal deviation, is recomputed for the next pair of acquired images,
β̅ is the depth target average value, and
α is a dimensionless parameter linking the depth to the movement of the sensor 12;

$$α = \frac{{D}_{max}}{{D}_{0}} \qquad ( 2 )$$

where Dₘₐₓ represents a maximum movement of the sensor 12 between two successive image acquisitions, and
D₀ represents a reference movement used during learning of the neural network 28.

The depth target average value β̅ is preferably predefined, and for example substantially equal to 0.5.

Also as an optional addition, the computing module 26 is configured to compute at least two intermediate maps 30 for the same scene S, the computed intermediate maps 30 having respective averages of indicative depth values that are different from one intermediate map 30 to the other. According to this optional addition, the computing module 26 is further configured to compute a merged intermediate map 45 by obtaining a weighted sum of the computed intermediate maps 30. According to this optional addition, the generating module 36 is then configured to generate the depth map 16 from the merged intermediate map 45.

According to this optional addition, the computing module 26 is for example further configured to perform partitioning in k-averages on a computed intermediate map 30, in order to determine n desired different respective averages for a later computation of n intermediate maps, n being an integer greater than or equal to 2.

In the example of FIG. 3 showing a block diagram of the electronic generating device 14 according to this optional addition, the partitioning of the intermediate map 30 in k-averages is done by a block K_m of the computing module 26, delivering, as output, the n desired different respective averages, such as n centroids C₁, . . . , Cₙ of the intermediate map 30 previously computed.

In FIG. 3, the computing module 26 includes, at the output of the block K_m, a block 1/β̅ configured to compute optimal movements D₁, . . . , Dₙ from centroids C₁, . . . , Cₙ derived from the block K_m and a depth target average value β̅. These optimal movements D₁, . . . , Dₙ are also called desired movements, or target movements.

Each optimal movement Dᵢ, where i is an integer index comprised between 1 and n representing the number of the corresponding respective average, or the corresponding centroid, is for example computed using the following equations:

$${D}_{i} = \frac{E ( {Ϛ}_{i} ( t ) )}{α \cdot \overline{β}} \qquad ( 3 )$$

where E( [symbol] ᵢ(t)) is the average of the values of the partitioned depth map [symbol] ᵢ(t) with index i,
β̅ is the depth target average value, and
α is the dimensionless parameter defined by the preceding equation (2).

According to FIG. 3, the computing module 26 includes, at the output of the block 1/β̅, a block INT configured to perform an integration of the optimal movements D₁, . . . , Dₙ in order to deduce therefrom, for each of the centroids C₁, . . . , Cₙ, on the one hand, a respective movement value D*₁, . . . , D*ₙ between the two images of the pair of successive images I_{t-Δt}, Iₜ of the scene S, and on the other hand, a corresponding recalculated temporal offset Δ₁, . . . , Δₙ, provided to the acquisition module 24 in order to perform a new acquisition of pairs of successive images (I_{t-Δ1}, Iₜ), . . . , (I_{t-Δn}, Iₜ) with these recomputed temporal offsets Δ₁, . . . , Δₙ.

Each movement D*ᵢ is for example computed using the following equation:

D*ᵢ=D(t,Δᵢ)=∥∫_{t-Δ}_{ᵢ}^{t}V(τ)·dτ∥ (4)

where V is the speed of the sensor 12 between the moments in time t−Δᵢ and t.

The speed of the sensor 12 is typically deduced from that of the drone 10, which is obtained via a measuring device or speed sensor, known in itself.

In FIG. 3, the computing module 26 then includes, at the output of the block INT and the neural network 28, a multiplier block, represented by the symbol “X”, configured to recompute the corresponding depth maps [symbol] ᵢ(t) for each partitioning with index i initially done and following the new acquisition of pairs of successive images (I_{t-Δ1}, Iₜ), . . . , (I_{t-Δn}, Iₜ) with these recomputed temporal offsets Δ₁, . . . , Δₙ.

Each partitioned depth map [symbol] ᵢ(t) for example verifies the following equation:

$${Ϛ}_{i} ( t ) = NN ( {I}_{t - {Δ}_{i}} , {I}_{t} ) \cdot \frac{{D}_{i}^{*}}{{D}_{0}} \qquad ( 5 )$$

where NN(I_{t-Δ}_{ᵢ},Iₜ) represents the new intermediate map 30 derived from the neural network 28 for the pair of successive images (I_{t-Δi}, Iₜ),

D*ᵢ represents the movement computed by the block INT, for example according to equation (4), and
D₀ represents the reference movement used during learning of the neural network 28.

The aforementioned equation (4) is also written in the form:

[symbol]

ᵢ(t)=α·β(I_{t-Δ}_{ᵢ},Iₜ)·D*ᵢ (6)

where α is the dimensionless parameter defined by the aforementioned equation (2), D*ᵢ represents the movement computed by the block INT, and
β(I_{t-Δ}_{ᵢ}, Iₜ) verifies the following equation:

$$β ( {I}_{t - {Δ}_{i}} , {I}_{t} ) = \frac{NN ( {I}_{t - {Δ}_{i}} , {I}_{t} )}{{D}_{max}} \qquad ( 7 )$$

with NN(I_{t-Δ}_{ᵢ},Iₜ) representing the new intermediate map 30 derived from the neural network 28 for the pair of successive images (I_{t-Δi}, Iₜ) and Dₘₐₓ representing the maximum movement of the sensor 12 between two successive image acquisitions.

In FIG. 3, the computing module 26 lastly includes, at the output of the neural network 28 and the multiplier block “X”, a FUSION block configured to compute the merged intermediate map 45 by obtaining a weighted sum of the computed intermediate maps 30, in particular positioned depth maps [symbol] ᵢ(t).

The weighted sum is preferably a weighted average, the sum of the weights of which is equal to 1.

The weighted sum, such as the weighted average, is for example done pixel by pixel where, for each pixel of the merged intermediate map 45, a weight set is computed.

The computation of the merged intermediate map 45 for example verifies the following equations:

ω_{i,j,k}ε+ƒ(β(I_{t-Δ}_{ᵢ},Iₜ)) (8)

where the function f is defined by:

$$\begin{matrix}F \text{:} x ↦ \{ \begin{matrix}0 & si x < {β}_{min} \\ \frac{x - {β}_{min}}{\overline{β} - {β}_{min}} & si {β}_{min} \leq x < \overline{β} \\ \frac{{β}_{max} - x}{{β}_{max} - \overline{β}} & si \overline{β} \leq x < {β}_{max} \\ 0 & si x \geq {β}_{max}\end{matrix} & ( 9 ) \\ {{Ϛ}_{FUSION} ( t )}_{j , k} = \frac{{\sum }_{i} {ω}_{i , jk , k} \cdot {{Ϛ}_{i} ( t )}_{j , k}}{{\sum }_{i} {ω}_{i , jk , k}} & ( 10 )\end{matrix}$$

where [symbol] _{FUSION}(t) designates the merged intermediate map 45,
i is the integer index comprised between 1 and n, defined above, j and k are indices on the x-axis and y-axis defining the pixel of the map in question, and
ε, βₘᵢₙ and βₘₐₓ are predefined parameters.

These parameters, as well as the depth target average value β̅, are preferably predefined, with values for example substantially equal to the following values:

ε=10⁻³; βₘᵢₙ=0.1; β̅=0.4 and βₘₐₓ=0.9.

One skilled in the art will note that equations (2), (5) to (7) depend on distance ratios and that the dimensionless parameter α and the partitioned depth map [symbol] ᵢ(t) alternatively verify the following equations depending on speed ratios instead of distance ratios, assuming that the speed of the image sensor 12 is constant between two successive image acquisitions:

$${α}^{′} = \frac{{V}_{max}}{{V}_{0}} \qquad ( 11 )$$

where Vₘₐₓ represents a maximum speed of the sensor 12, and
V₀ represents a reference speed used during learning of the neural network 28.

$${Ϛ}_{i} ( t ) = NN ( {I}_{t - {Δ}_{i}} , {I}_{t} ) \cdot \frac{{V}_{i}}{{V}_{0}} \qquad ( 12 )$$

where NN(I_{t-Δ}_{ᵢ},Iₜ) represents the new intermediate map 30 derived from the neural network 28 for the pair of successive images (I_{t-Δi}, Iₜ),

Vᵢ represents the speed of the sensor 12 during this new image acquisition, and
V₀ represents the reference speed used during learning of the neural network 28.

The aforementioned equation (12) is also written in the form:

[symbol]

ᵢ(t)=α′·γ(I_{t-Δ}_{ᵢ},Iₜ)·Vᵢ (13)

where α′ is the dimensionless parameter defined by the aforementioned equation (11), Vᵢ represents the speed of the sensor 12 during this new image acquisition, and γ(I_{t-Δ}_{ᵢ},Iₜ) verifies the following equation:

$$γ ( {I}_{t - {Δ}_{i}} , {I}_{t} ) = \frac{NN ( {I}_{t - {Δ}_{i}} , {I}_{t} )}{{V}_{max}} \qquad ( 14 )$$

with NN(I_{t-Δ}_{ᵢ},Iₜ) representing the new intermediate map 30 derived from the neural network 28 for the pair of successive images (I_{t-Δi},Iₜ) and Vₘₐₓ representing the maximum speed of the sensor 12.

The neural network 28 includes a plurality of artificial neurons 46 organized in successive layers 48, 50, 52, 54, i.e., an input layer 48 corresponding to the input variable(s) 32, an output layer 50 corresponding to the output variable(s) 34, and optional intermediate layers 52, 54, also called hidden layers and arranged between the input layer 48 and the output layer 50, as shown in FIG. 2. An activation function characterizing each artificial neuron 46 is for example a nonlinear function, for example of the Rectified Linear Unit (ReLU) type. The initial synaptic weight values are for example set randomly or pseudo-randomly.

The artificial neural network 28 is in particular a convolutional neural network. The artificial neural network 28 for example includes artificial neurons 46 arranged in successive processing layers.

The artificial neural network 28 includes one or several convolution kernels. A convolution kernel analyzes a characteristic of the image to obtain, from the original image, a new characteristic of the image in a given layer, this new characteristic of the image also being called channel (also referred to as a feature map). The set of channels forms a convolutional processing layer, in fact corresponding to a volume, often called output volume, and the output volume is comparable to an intermediate image.

The artificial neural network 28 includes one or several convolution kernels arranged between the convolution kernels and the output variable(s) 34.

The learning of the neural network 28 is supervised. It then for example uses a back-propagation algorithm of the error gradient, such as an algorithm based on minimizing an error criterion by using a so-called gradient descent method.

The supervised learning of the neural network 28 is done by providing it, as input variable(s) 32, with one or several pair(s) of acquired images I_{t-Δt}, Iₜ and, as reference output variable(s) 34, with one or several corresponding intermediate map(s) 30, with the expected depth values for the acquired image pair(s) I_{t-Δt}, Iₜ provided as input variable(s) 32.

The learning of the neural network 28 is preferably done with a predefined temporal deviation Δ₀ between two successive image acquisitions. This temporal deviation typically corresponds to the temporal period between two image acquisitions of the sensor 12 operating in video mode, or conversely to the corresponding frequency. Depending on the sensor 12, the image acquisition for example varies between 25 images per second, or even 120 images per second. The predefined temporal deviation Δ₀ is then comprised between 40 ms and 16 ms, or even 8 ms.

During the learning of the neural network 28, the speed of the sensor 12 being assumed to be constant between two image acquisitions and equal to V₀, also called reference speed, the predefined temporal deviation Δ₀ corresponds to a predefined movement D₀ of the sensor 12, also called reference movement.

The acquired pair of images I_{t-Δt}, Iₜ, provided as input variable 32 for the neural network 28, preferably has dimensions smaller than or equal to 512 pixels×512 pixels.

The generating module 36 is configured to generate the depth map 16 from the at least one computed intermediate map 30 or from the merged intermediate map 45, said merged immediate map 45 in turn resulting from computed intermediate maps 30.

The generating module 36 is preferably configured to generate the depth map 16 by applying a corrective scale factor to the or each computed intermediate map 30, or to the merged intermediate map 45 if applicable. The corrective scale factor depends on a ratio between the temporal deviation Δt between the images of the acquired pair from which the intermediate map 30 has been computed and a predefined temporal deviation Δ₀, used for prior learning of the neural network 28.

When the speed of the sensor 12 is further assumed to be constant between two image acquisitions, the corrective scale factor depends, similarly, on a ratio between the movement D(t,Δt) of the sensor 12 between the two image acquisitions for the acquired pair from which the intermediate map 30 has been computed and the predefined movement D₀, used for the prior learning of the neural network 28.

The corrective scale factor is then equal to D(t,Δt)/D₀, and the corrected depth map for example verifies the following equation:

$$Ϛ ( t ) = NN ( {I}_{t - Δ t} , {I}_{t} ) \cdot \frac{D ( t , Δ t )}{{D}_{0}} \qquad ( 15 )$$

where NN(I_{t-Δt},Iₜ) represents the intermediate map 30 derived from the neural network 28 for the pair of successive images (I_{t-Δt}, Iₜ),
D(t,Δt) represents said movement of the sensor 12 between the two image acquisitions, and
D₀ represents the aforementioned reference movement.

Said movement D(t,Δt) for example verifies the following equation:

D(t,Δt)=∥∫_{t-Δt}^{t}V(τ)·dτ∥ (16)

where V is the speed of the sensor 12 between the moments in time t−Δt and t.

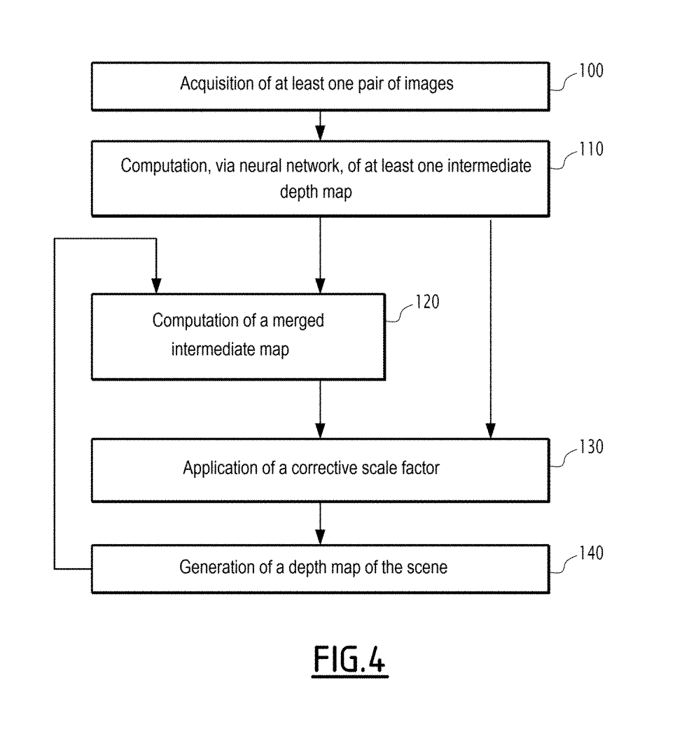

The operation of the drone 10 according to the invention, in particular its electronic generating module 14, will now be described using FIG. 4, illustrating a flowchart of the determination method according to the invention, implemented by computer.

During an initial step 100, the electronic generating device 14 acquires, via its acquisition module 24, at least one pair of successive images of the scene S from among the various images taken by the image sensor 12.

The electronic generating device 14 computes, during the following step 110 and via its computing module 26, in particular via its neural network 28, at least one intermediate depth map 30, the neural network 28 receiving, as previously indicated, each acquired pair of successive images in one of its input variables 32 and delivering the computed intermediate map 30 from said pair of acquired images in the respective one of its output variables 34.

As an optional addition, the electronic generating device 14 computes, via its computing module 26 and during a following optional step 120, the merged intermediate map 45 by obtaining the weighted sum of at least two intermediate maps 30 computed for the same scene S, the computed intermediate maps 30 having respective averages of indicative depth values that are different from one intermediate map to the other.

The computation of the merged intermediate map 45 with said weighted sum is for example done using the FUSION block of FIG. 3 and according to equations (8) to (10) previously described.

To determine different intermediate maps 30 intended to be merged, the computing module of 36 further performs, according to an optional addition and for example using the unit K_m, the partitioning in k-averages on the intermediate map 30 previously computed, in order to determine n desired separate respective averages for the subsequent computation of n intermediate maps 30. The n desired separate respective averages, such as the n centroids C₁, . . . , Cₙ, are next provided to the successive units 1/β̅, INT, shown in FIG. 3, to recompute the temporal offsets Δ₁, . . . , Δₙ, these temporal offsets Δ₁, . . . , Δₙ in turn being provided to the acquisition module 24 for a new acquisition of pairs of successive images (I_{t-Δ1}, Iₜ), . . . , (I_{t-Δn}, Iₜ). The n subsequent intermediate maps 30 are then computed by the neural network 28 to next be transmitted to the FUSION unit in order to compute the merged intermediate map 45.

As an optional addition, the electronic generating device 14 computes, via its generating module 36 and during the following optional step 130, a corrective scale factor to be applied directly to the intermediate map 30 computed by the neural network 28, or to the merged intermediate map 45. The application of the corrective scale factor for example verifies equations (15) and (16) previously described, and makes it possible to correct the intermediate map based on any offset between the predefined temporal deviation Δ₀, used for the prior learning of the neural network 28, and the temporal deviation Δr between the images of the acquired pair, from which the intermediate map 30 has been computed.

The electronic generating device 14 lastly generates, during step 140 and via its generating module 36, the depth map 16 of the scene S.

One skilled in the art will understand that when the optional steps 120 and 130 for computing the merged map 45 and respectively applying the corrective scale factor are not carried out and the electronic generating device 14 goes directly from step 110 to step 140, the depth map 16 is generated directly from the intermediate map 30 derived from the neural network 28. In other words, the depth map 16 generated by the generating module 34 is then identical to the intermediate map 30 derived from the neural network 28 of the computing module.

The electronic generating device 14 then makes it possible to provide a depth map 16 of the scene S with good precision and quickly through the use of the neural network 28. The average depth error between the depth thus estimated and the actual depth has a small value.

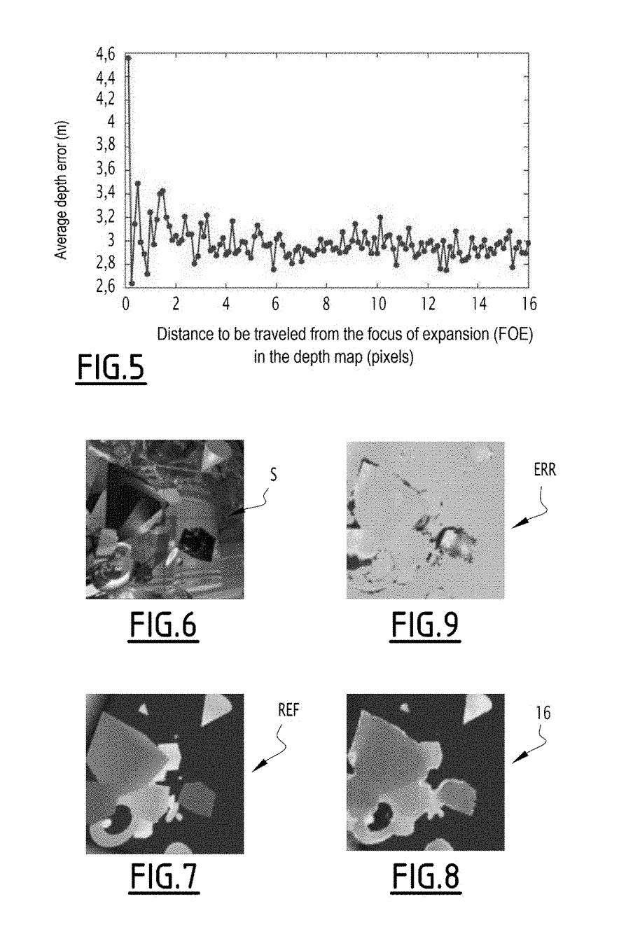

For example, in FIG. 5 showing an evolution curve of the average depth error, expressed in meters, as a function of the distance, from the focus of expansion (FOE), in the depth map, expressed in pixels, the average error is almost systematically less than 3.5 m, excluding the isolated average error value substantially equal to 4.6 m for a very small distance in the depth map. The average error is even generally substantially equal to 3 m.

This good precision of the determination of the depth map 16 by the electronic generating device 14 is also visible in FIGS. 6 to 9, illustrating the results obtained by the electronic generating device 14 according to the invention compared with a reference computation of the depth map of the scene. FIG. 6 shows an actual image of the scene S, FIG. 7 shows the depth map, denoted REF, obtained with the reference computation, and FIG. 8 shows the depth map 16 obtained with the generating device 14 according to the invention. FIG. 9, showing the depth errors between the depth map 16 obtained with the generating device 14 and the depth map REF obtained with the reference computation, then confirms this proper positioning with small depth errors.

In FIG. 9, the average gray level corresponding to an initial green color represents an absence of error; the high gray level, i.e., a light gray level, corresponding to an initial red color represents an overestimate of the depth; and the low gray level, i.e., a dark gray level, corresponding to an initial blue color represents an underestimate of the depth. One skilled in the art will then note that the large majority of FIG. 9 corresponds to average gray zones, i.e., zones with an absence of depth error.

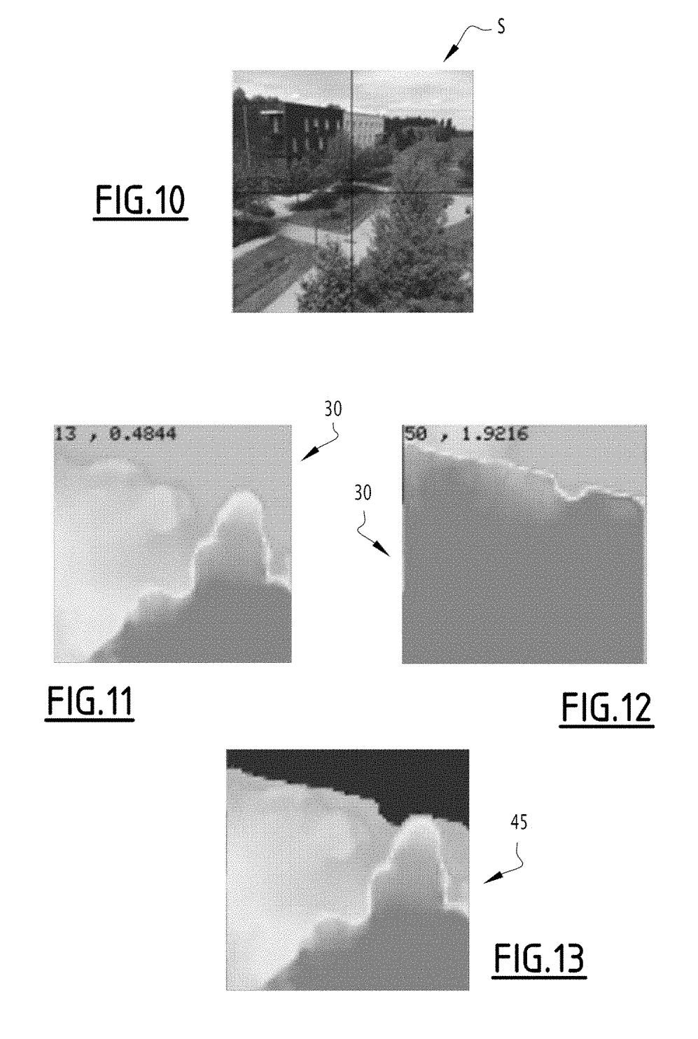

When, as an optional addition, the electronic generating device 14 further computes the merged intermediate map 45 by obtaining the weighted sum of at least two intermediate maps 30 computed for the same scene S, the depth map 16 thus obtained has a wider range of depth values, as illustrated in FIGS. 10 to 13.

FIG. 10 shows an actual image of the scene S; FIG. 11 shows a first intermediate depth map 30 having an average of depth values substantially equal to 13 m, the range of depth values typically being comprised between 0 and 50 m; and FIG. 12 shows a second intermediate depth map 30 having an average of depth values substantially equal to 50 m, the range of depth values typically being comprised between 50 and 100 m.

FIG. 13 then shows the merged intermediate map 45 resulting from the merging of the first and second intermediate depth maps 30, visible in FIGS. 11 and 12. The depth map 16 generated by the electronic generating device 14 from the merged intermediate map 45 then has a wider range of depth values, typically comprised between 0 and 100 m.

One skilled in the art will therefore understand that the electronic generating device 14 according to the invention then allows the drone 10 to perform more effective obstacle detection.

One can then see that the electronic generating device 14 according to the invention and the associated generating method allow more effective generation of the depth map 16 of the scene S, from at least one pair of successive images I_{t-Δt}, Iₜ of the scene S.

1. An electronic device for generating, from at least one pair of successive images of a scene including a set of object(s), a depth map of the scene, the device comprising:
an acquisition module configured to acquire at least one pair of successive images, taken by an image sensor, of the scene including the set of object(s),
a computation module configured to compute, via a neural network, at least one intermediate depth map, each intermediate map being computed for a respective acquired pair of images and having a value indicative of a depth for each object of the scene, the depth being the distance between the sensor and a plane passing through the respective object, parallel to a reference plane of the sensor, an input variable of the neural network being the acquired pair of images, an output variable of the neural network being the intermediate map,
a generating module configured to generate the depth map of the scene from at least one computed intermediate map, the depth map including a set of element(s), each element being associated with an object and having a value dependent on the depth between the sensor and said object.

2. The device according to claim 1, wherein the computing module is configured to compute at least two intermediate maps for the same scene.

3. The device according to claim 2, wherein the computing module is further configured to modify an average of the indicative depth values between first and second intermediate maps, respectively computed for first and second pairs of acquired images, by selecting the second pair with a temporal deviation between the images that is modified relative to that of the first pair.

4. The device according to claim 3, wherein the computing module is configured to compute at least two intermediate maps for the same scene, and
wherein the computing module is configured to compute at least two intermediate maps for the same scene, the computed intermediate maps having respective averages with indicative depth values that are different from one intermediate map to the other, and further for computing a merged intermediate map by obtaining a weighted sum of the computed intermediate maps, and
the generating module is configured to generate the depth map from the merged intermediate map.

5. The device according to claim 4, wherein the computing module is configured to perform partitioning in k-averages on a computed intermediate map, in order to determine n desired different respective averages for a later computation of n intermediate maps, n being an integer greater than or equal to 2.

6. The device according to claim 1, wherein the generating module is configured to generate the depth map by applying a corrective scale factor to the or each computed intermediate map, the corrective scale factor depending on a ratio between the temporal deviation between the images of the acquired pair for which the intermediate map has been computed and a predefined temporal deviation, used for prior learning of the neural network.

7. The device according to claim 1, wherein each element of the depth map is a pixel, and each object is the entity of the scene corresponding to the pixel of the taken image.

8. The device according to claim 1, wherein the image sensor extends along an extension plane, and the reference plane is a plane parallel to the extension plane.

9. The device according to claim 1, wherein the image sensor extends along an extension plane, and the reference plane is combined with the extension plane.

10. A drone, comprising:
an image sensor configured to take at least one pair of successive images of a scene including a set of object(s),
an electronic generating device configured to generate a depth map of the scene, from the at least one pair of successive images of the scene taken by the sensor,
wherein in that the electronic generating device is according to claim 1.

11. A method for generating, from at least one pair of successive images of a scene including a set of object(s), a depth map of the scene,
the method being implemented by an electronic generating device, and comprising:
acquiring at least one pair of successive images, taken by an image sensor, of the scene including the set of object(s),
computing, via a neural network, at least one intermediate depth map, each intermediate map being computed for a respective acquired pair of images and having a value indicative of a depth for each object of the scene, the depth being the distance between the sensor and a plane passing through the respective object, parallel to a reference plane of the sensor, an input variable of the neural network being the acquired pair of images, an output variable of the neural network being the intermediate map, and
generating the depth map of the scene from at least one computed intermediate map, the depth map including a set of element(s), each element being associated with an object and having a value dependent on the depth between the sensor and said object.

12. A non-transitory computer-readable medium including a computer program comprising software instructions which, when executed by a computer, carry out a method according to claim 11.
